(19) United States
(12) Patent Application Publication
(10) Pub. No.: US 2012/0041487 A1
(43) Pub. Date: Feb. 16, 2012

(54) Tethering Strap and Combined First and Second Body Harnesses for the Attachment of a Pacifier

(76) Inventor: Katrina Griffis, Callaway, MD (US)

(21) Appl. No.: 13/163,827

(22) Filed: Jun. 20, 2011

Related U.S. Application Data
(60) Provisional application No. 61/372,113, filed on Aug. 10, 2010.

(51) Int. Cl. A61J 17/00

(52) U.S. Cl. 606/234

(57) ABSTRACT

A pacifier accessory which includes a tethering strap and combined first and second body harnesses for the attachment of a pacifier, wherein the first and second body harnesses each include a horizontal strap. Each horizontal strap includes a fastening mechanism. The tether strap is connected at one end to the combined first and second body harnesses perpendicularly. The other end of the tether strap is connected to a ring. The ring is attached to an article via a clip. Alternatively, the ring is connected to a pacifier.

### CROSS-REFERENCE TO RELATED APPLICATIONS

The application claims the benefit of priority of U.S. Provisional Application Ser. No. 61/372,113 filed on Aug. 10, 2010, the disclosure of which is incorporated herein by reference in its entirety.

### FIELD OF INVENTION

The present disclosure relates to infant accessories. In particular, the present disclosure related to infant accessories attached to pacifiers.

### BACKGROUND OF THE INVENTION

Pacifiers are a very common infant accessory that parents use to calm a small child. Very often parents purchase many pacifiers because they are often lost or misplaced. The small child may not want or need the pacifier at all times. The pacifier can be dropped accidentally from the small child's mouth or hand while going about day to day tasks resulting in a temporary or permanent loss. In these instances, the pacifier can become unsanitary. In some instances, the pacifier is misplaced or just not readily available when the small child wants the pacifier again; this can become a major disturbance or inconvenience.

Currently there are many types of pacifier holders on the market, all of which perform several functions and address certain issues. However, none of the holders incorporate a body harness for the attachment of a pacifier.

U.S. Pat. No. 4,765,037 entitled PACIFIER STRAP, U.S. Pat. No. 4,903,698 entitled PACIFIER STRAP AND FASTENER FOR ATTACHMENT TO A GARMENT, U.S. Design Pat. No. D310716 entitled PACIFIER TETHER, U.S. Pat. No. 4,972,980 entitled PACIFIER HOLDER, U.S. Pat. No. 4,985,968 entitled FASTENER MEANS FOR PACIFIERS, TOYS, BADGES AND LIKE ARTICLES, U.S. Pat. No. 4,995,075 entitled INFANT PACIFIER ASSEMBLY HOLDER, U.S. Pat. No. 5,150,504 entitled UNIVERSAL TETHER APPARATUS, U.S. Design Pat. No. D415837 entitled PACIFIER SECUREMENT STRAP, U.S. Pat. No. 6,312,449 entitled PACIFIER RETAINING DEVICE, U.S. Pat. No. 4,990,157 entitled SOOTHER RETAINER, and U.S. Design Pat. No. D225039 entitled RETRACTIBLE CLIP ON PACIFIER are examples of conventional pacifier holders that include traditional tether straps, but none of which include a tether strap connected to a harness for attachment to a pacifier.

Moreover, there are also several disclosures for dog harnesses, such as, for example, U.S. Design Pat. No. D571058 entitled DOG HARNESS, U.S. Pat. No. 4,852,336 entitled HALTER WITH POP-RELEASE FASTENER MEANS, U.S. Pat. No. 5,370,083 entitled LEASH CONTROLLABLE DOG HARNESS, U.S. Pat. No. 2,826,172 entitled ANIMAL ACTUATED RESTRAINING DOG HARNESS, U.S. Pat. No. 5,611,298 entitled CONTROLLED DOG HARNESS AND LEASH ASSEMBLY and U.S. Pat. No. 5,937,794 entitled SLED DOG. However, none of the dog harnesses include a tether trap combined with first and second body harnesses for attachment with a pacifier.

This present disclosure relates to infant accessories, and more specifically to a pacifier accessory including a tether strap and combined first and second body harnesses for the secure attachment of a pacifier.

### SUMMARY OF THE INVENTION

Exemplary embodiments disclosed herein provide a pacifier accessory which includes a tethering strap and combined first and second body harnesses for the attachment of a pacifier, wherein the first and second body harnesses each include a horizontal strap. Each horizontal strap includes a fastening mechanism. The tether strap is connected at one end to the combined first and second body harnesses perpendicularly, and the other end of the tether strap is connected to a ring. The ring is attached to an article via a clip. In another exemplary embodiment the ring is connected to a pacifier.

### BRIEF DESCRIPTION OF THE DRAWINGS

FIG. 1 is a schematic top view of a tethering strap and combined first and second body harnesses secured to a stuffed animal with attached pacifier.

FIG. 2 is a schematic side view of the tethering strap and combined first and second body harnesses secured to a stuffed animal with attached pacifier.

FIG. 3 is a schematic bottom view of the tethering strap and combined first and second body harnesses secured to a stuffed animal with attached pacifier.

FIG. 4 is a schematic top view of the tethering strap and combined first and second body harnesses.

FIG. 5 is a schematic side view of the tethering strap and combined first and second body harnesses.

FIG. 6 is a schematic bottom view of the tethering strap and combined first and second body harnesses.

FIG. 7 is a schematic bottom view of an embodiment of a hook and loop closure.

### DETAILED DESCRIPTION

The present disclosure describes a secure means of attaching an infant accessory, such as, for example, a stuffed toy with attached pacifier 103, to an article to provide a secure means of transport. A tethering strap 109 and combined first 108 and second 107 body harnesses is adapted to fit securely around the body of the stuffed toy 103 at one end and to a ring 102 and clip 101 that attaches to an article at the other end. A ring 102 engaging end of the tethering strap 109 may be looped through the interior of the ring 102 and sewn together around the ring 102 for a secure attachment to the ring 102. While the present disclosure makes reference to an infant pacifier, it is recognized that other articles, such as, for example, teething rings or the like may be used.

In another exemplary embodiment, the tethering strap 109 and combined first 108 and second 107 body harnesses is adapted to fit securely around a small child at one end and to a ring at the other end. The first body harness is adjustably secured to fit around the small child's chest and the second body harness is adjustably secured to fit around the small child's lower abdomen. The ring is securely attached to a pacifier.

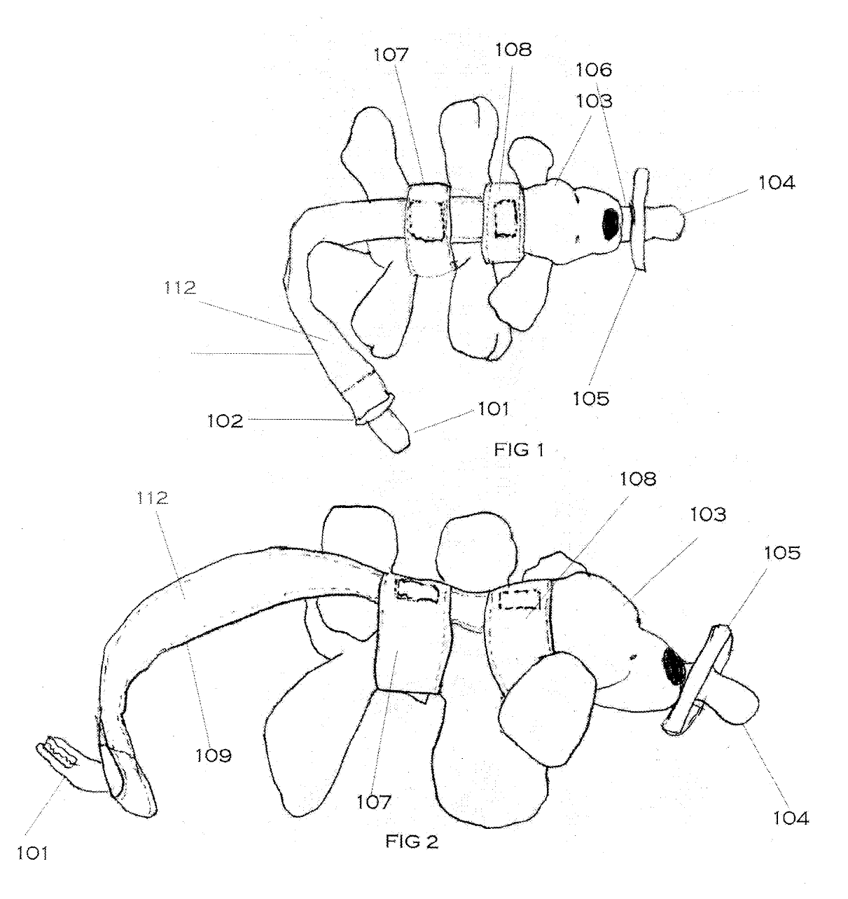

FIG. 1 illustrates a top view of the present embodiment of the tethering strap 109 and combined first 108 and second 107 body harnesses securely attached to a stuffed toy with a pacifier. The tethering strap 109 and combined first 108 and second 107 body harnesses has a first harness strap 108 and second harness strap 107 constructed with cotton or polyester ribbon. The ribbon 112 is cut into two matching sections and sewn together to form the tethering strap 109. This means of construction is used, for example, for constructing the first harness strap 108 and second harness strap 107.

The first harness strap 108 and the second harness strap 107 can be of any suitable dimensions, and in an exemplary embodiment the first harness strap is 5 inches long and ⅝ inches wide, and the second harness strap 107 is 6 inches long and ⅝ inches wide. The tethering strap 109 can be of any suitable dimension, and in an exemplary embodiment the tethering strap is 7 inches long and ⅝ inches wide. The first strap 108 is formed by folding the allowance of the tethering strap 109 under the first harness strap and securing the tethering strap 109 with a box stitch. The second harness strap 107 is box stitched to the tethering strap 109 one half inch from the first strap harness 108. A fastening mechanism, such as, for example, a hook 113 and loop 114 is attached to the ends of the first harness strap 108 and second harness strap 107.

The tethering strap and combined first and second body harnesses can be constructed from a number of different materials, such as, for example, cotton, polyester, elastic ribbon or webbing. Moreover, the first harness strap 108 and second harness strap 107 can be secured with any fastening mechanism, such as, for example, hook and loop or a metal snap.

FIG. 2 illustrates a side view of the tethering strap 109 and combined first 108 and second 107 body harnesses secured to a stuffed toy with pacifier attachment.

FIG. 3 illustrates a bottom view of the tethering strap 109 and combined first 108 and second 107 body harnesses secured to a stuffed toy with pacifier attachment 103. In an exemplary embodiment, the first harness strap 108 and second harness strap 107 can be secured with a ⅝ inch Female (button and socket) Snap Fastener 110 and Male (eyelet and stud) Snap Fastener 111.

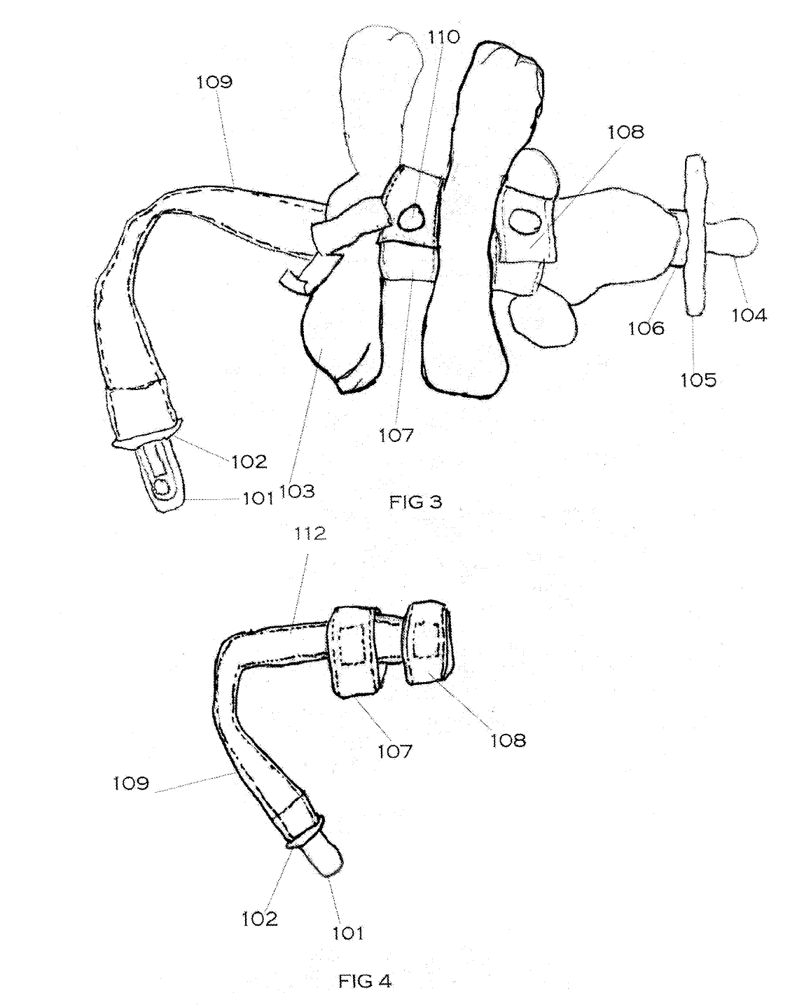

FIG. 4 illustrates a top view of the tethering strap 109 and combined first 108 and second 107 body harnesses.

FIG. 5 illustrates a top view of the tethering strap 109 and combined first 108 and second 107 body harnesses.

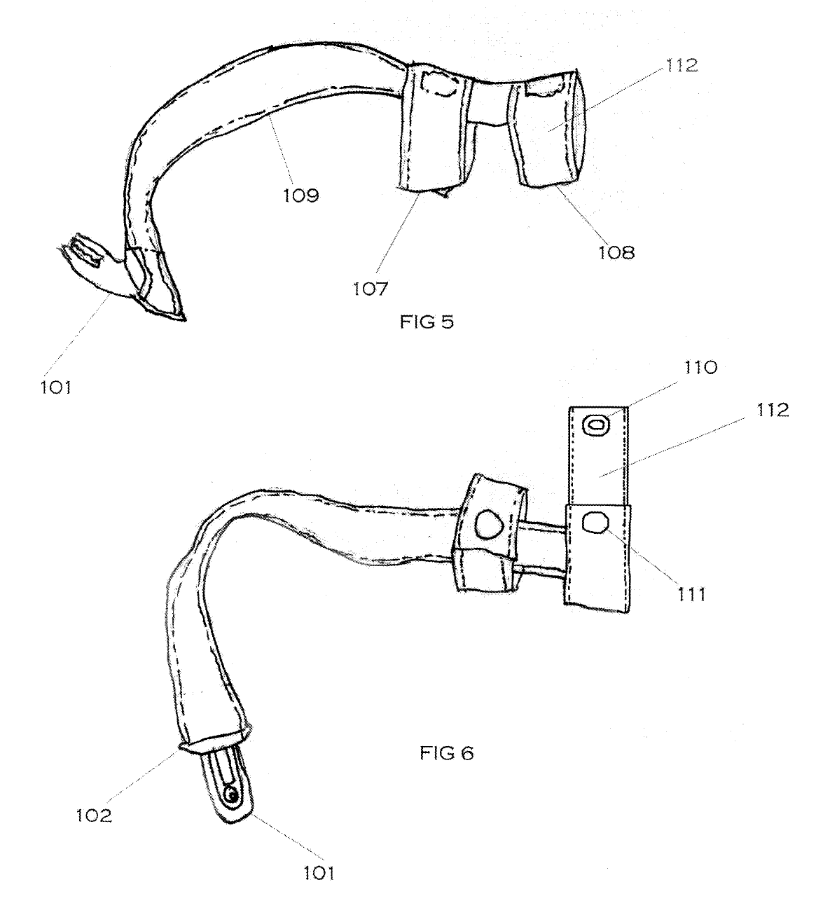

FIG. 6 illustrates a top view of the tethering strap 109 and combined first 108 and second 107 body harnesses.

OPERATION-FIGS. 1-3

A user will open the fastening mechanism that secures the first 108 and second 107 body harnesses around the stuffed toy with pacifier attachment 103. Next the user will wrap the first harness strap 108 around the neck of the stuffed toy 103 and will wrap the second harness strap 107 around the body of the stuffed toy 103. The ends of the first harness strap 108 and second harness strap 107 will be secured with a fastening mechanism, such as, for example, a ⅝ inch Female (button and socket) Snap Fastener 110 and a Male (eyelet and stud) Snap Fastener 111 or a hook 113 and loop 114 closure. The clip 101 is attached to the remote end of the tethering strap 109 and is secured to an article of clothing, car seat strap or stroller strap.

In another exemplary embodiment, the user will wrap the first harness strap 108 around the chest of a small child and will wrap the second harness strap 107 around the lower abdomen of the small child. The ends of the first harness strap 108 and second harness strap 107 will be secured with a fastening mechanism, such as, for example, a ⅝ inch Female (button and socket) Snap Fastener 110 and a Male (eyelet and stud) Snap Fastener 111 or a hook 113 and loop 114 closure. The first body harness and second body harness are adjustably secured to the small child so as not to cause discomfort. Ring 102 is securely attached to a pacifier.

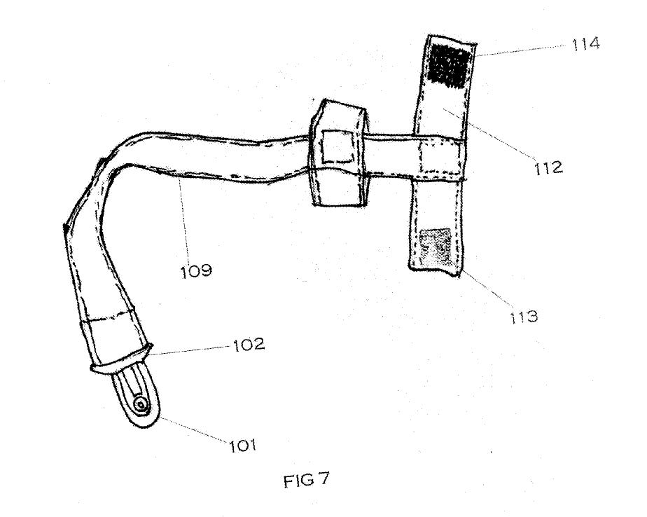

As illustrated in FIG. 7, hook 113 and loop 114 closures are included on the first harness strap 108 and second harness strap 107 as a means of adjustably securing the body of the stuffed toy with pacifier attachment 103 to the harness, or alternatively as a means of adjustably securing the first harness strap 108 and second harness strap 107 to a small child.

With respect to the above description, it is to be realized that the optimal dimensional relationships for the parts described in the present disclosure, to include variations in size, materials, shape, form, function and manner of operation, assembly and use, are deemed readily apparent and obvious to one skilled in the art, and all equivalent relationships to those illustrated in the drawings and described herein are intended to be encompassed by the present disclosure.

These descriptions are not inclusive and many other modifications and variations will be apparent to someone of ordinary skill in the art with construction skills in the related arts. Together these descriptions and accompanying illustrations seek to provide an explanation of the basic principles of the embodiment and its application.

Moreover, while illustrative embodiments of the invention have been described herein, further embodiments can include equivalent elements, modifications, omissions, combinations (e.g., of aspects across various embodiments) adaptations and/or alterations as would be appreciated by those skilled in the art based on the present disclosure.

What is claimed:

1. A pacifier accessory comprising:
a tethering strap coupled to a ring at one end and coupled perpendicular to a harness at an opposing end of the strap;
the harness includes a first horizontal strap and a second horizontal strap, wherein each strap includes a fastening mechanism.

2. The pacifier accessory of claim 1, wherein the tethering strap includes a loop engaging end which is connected to the ring.

3. The pacifier accessory of claim 1, wherein the ring is connected to a clip.

4. The pacifier accessory of claim 3, wherein the first horizontal strap securely attaches around a stuffed toy's neck and the second horizontal strap is securely attached around the stuffed toy's body.

5. The pacifier accessory of claim 1, wherein the first horizontal strap securely attaches adjustably around the chest of a small child and wherein the second horizontal strap securely attaches adjustably around the lower abdomen of the small child.

6. The pacifier accessory of claim 4, wherein the clip is connected to an article.

7. The pacifier accessory of claim 5, wherein the ring is connected to a pacifier.

8. The pacifier accessory of claim 1, wherein the fastening mechanism includes a hook and loop closure or snaps.

9. The pacifier accessory of claim 6, wherein the article is any one of a stroller strap, car seat strap or clothing.

10. The pacifier accessory of claim 5, wherein the first horizontal strap and second horizontal strap fit adjustably around a small child using the fastening mechanism.
